(19) United States
(12) Patent Application Publication
(10) Pub. No.: US 2015/0318636 A1
(43) Pub. Date: Nov. 5, 2015

(54) ELECTRICAL PLUG-IN CONNECTOR

(71) Applicant: ERNI PRODUCTION GMBH & CO. KG, Adelberg (DE)

(72) Inventor: Juergen LAPPOEHN, Gammelshausen (DE)

(73) Assignee: ERNI Production GmbH & Co. KG, Adelberg (DE)

(21) Appl. No.: 14/654,059

(22) PCT Filed: Dec. 17, 2013
(86) PCT No.: PCT/DE2013/000812

§ 371 Date: Jun. 19, 2015

(30) Foreign Application Priority Data
Dec. 21, 2012 (DE) 10 2012 025 106.8

(51) Int. Cl. H01R 13/508

(52) U.S. Cl. CPC H01R 13/508

(57) ABSTRACT

An electrical plug-in connector having a first housing part and having a second housing part, blade contact elements being arranged in the first or second housing part and spring contact elements being arranged in the second or first housing part which are adapted to the blade contacts and can be inserted therein, has a locking clip which, when it engages around the first or second housing part in a manner substantially parallel to the plug-in direction when the two housing parts are plugged into each other, can be locked in or on the second or first housing part.

The invention relates to an electrical plug-in connector having a first housing part and a second housing part, wherein blade contact elements are arranged in the first or second housing part and spring contact elements which are adapted to the blade contact elements and are able to be inserted into them are arranged in the second or first housing part.

### PRIOR ART

Such plug-in connectors are widespread in the prior art.

Thus, for example, an electrical plug-in connector of the type conforming to its genre arises from DE 10 2004 054 203 A1, in which an insulation displacement plug-in contact strip is provided.

DE 10 2008 019 016 A1 discloses an electrical plug-in connector that has locking clips for locking two housing parts. Two locking clips are provided which are mounted for rotation on bearing pins arranged on a housing part of the plug-in connector. This rotatable mounting of both locking clips requires complex, time-consuming production; moreover, the bearing pins and, in particular, the locking protrusions that serve for the locking are easily exposed to damage. In addition, two locking clips must be actuated and arrested in order to ensure a secure locking of both housing parts of the plug-in connector.

A similar secondary locking agent on a plug-in connector housing arises from DE 10 2010 032 013 A1. In this case as well, both locking clips must be mounted for rotation on a housing part. Two locking clips are also provided here.

### DISCLOSURE OF THE INVENTION

### Advantages of the Invention

The electrical plug-in connector according to the invention having the features of claim 1, in contrast, has the advantage that the locking clip does not have to be fastened to a housing, but rather can be handled as a separate component. This is therefore advantageous because, for example, if the locking clip is damaged, an exchange of the locking clip with an undamaged locking clip is easily possible. Furthermore, the locking clip according to the invention is designed to be substantially more massive and stable than the locking clips known from the prior art. It is particularly advantageous that the locking clip according to the invention is, in particular, able to be a secondary locking clip which provides additional security for a plug-in connection that is already locked, such that this is able to be used in particularly critical environments (for example environments that are subject to heavy vibrations and so forth). A tongue having a latching hook, arranged on the second housing part, for example, and an opening arranged in the first housing part, with which opening the latching hook engages, are provided as the primary locking agent. A locking clip is provided according to the invention which is able to be locked in/on the second or first housing part while it encloses the first or second housing part substantially parallel to the plugging direction, when both housing parts are plugged into each other. A particularly stable connection of the two plug-in connector parts that are plugged into each other is hereby implemented.

By the measures specified in the dependent claims, advantageous developments and improvements of the plug-in connector specified in claim 1 are possible.

One advantageous embodiment thus provides that guide elements for guiding the clip arms of the locking clip, which run substantially parallel to the plugging direction, are arranged in the first or second housing part. In this way, a precise guiding of the locking clip on the one housing part is implemented and, at the same time, a fastening of the clip arms of the locking clip to the housing part is also enabled.

Moreover, provision is advantageously made for latch elements for locking with the counterpart latch elements arranged on the clip arms to be provided in the second or first housing part. The counterpart latch elements arranged on the clip arms lock with the latch elements, wherein a precise guiding, and therefore also a precise locking of the latch elements to one another is ensured by the guide elements.

Purely as a matter of principle, the locking clips may be designed in a different manner. One particularly advantageous embodiment provides that the locking clips are designed in a U shape with two U-shaped legs that are bent fundamentally orthogonally from a base. Such a U-shaped design is used particularly advantageously in the case of mostly cuboidal plug-in connector housing parts.

Provision is highly advantageously made for the U-shaped legs to have grooves as guide elements on their respective inner side facing the first or second housing part, with which grooves protrusions that are adapted to them and are arranged on the outer sides running parallel to the plugging direction engage in a sliding manner. The guide elements are therefore implemented by grooves and by protrusions engaging therewith. This enables, on the one hand, a precise guiding of the locking clip, but on the other hand enables an optimal fastening of the locking clip to the housing part having the protrusions.

Provision is particularly advantageously made for the U-shaped legs to have latching hooks as counterpart elements on their ends, said latching hooks interacting with snap-in noses arranged on the first or second housing part. The interaction of the grooves, together with the protrusions and the latching hooks, with the snap-in noses arranged on the housing part enables precise guiding of the U-shaped legs and thus also a precise latching of the latching hooks into the snap-in noses. In order to simplify this latching, provision is advantageously made for the latching hooks and the snap-in noses to have sliding surfaces on their sides facing one another that are adapted to one another and that run obliquely.

The locking clips can, purely as a matter of principle, consist of highly different materials. They are particularly advantageously designed as a plastic part which is not only easy to produce, but is also particularly light and at the same time has insulating properties.

### BRIEF DESCRIPTION OF THE DRAWINGS

One exemplary embodiment of the invention is depicted in the drawings and illustrated in greater detail in the description below.

Shown are:

FIG. 1 an isometric depiction of a plug-in connector according to the invention before both housing parts are plugged into each other and of the locking clip;

FIG. 2 an isometric depiction of the plug-in connector depicted in FIG. 1 after both plugged into each other and before the fastening of the locking clip, and

FIG. 3 the plug-in connector according to the invention depicted in FIG. 1 and FIG. 2 when both housing parts are plugged into each other and when the locking clip is plugged in.

### EMBODIMENTS OF THE INVENTION

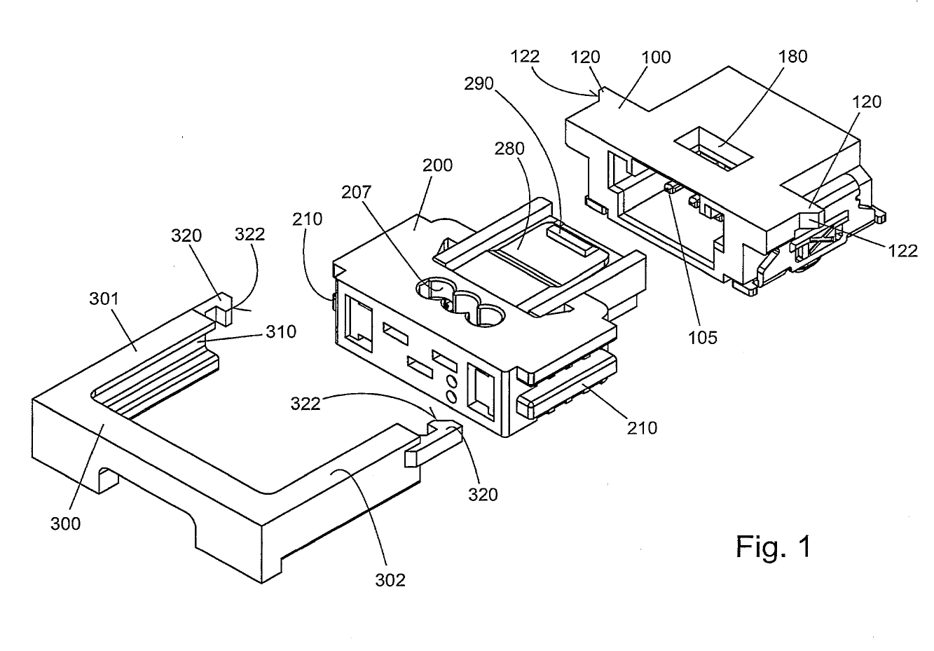

An electrical plug-in connector, depicted in FIGS. 1 to 3 in different plugging states, has a first housing part 100 in which first plug contact elements, for example blade contact elements 105, are arranged. Adapted to this first housing part 100 is a second housing part 200, which is able to be plugged into the first housing part 100 in a manner that is known in itself, and in which corresponding counterpart contact elements, i.e. spring contacts (not visible here) are arranged.

A locking clip 300 is moreover provided, which has a substantially U-shaped configuration with U-shaped legs. 301, 302. The inner side of the U-shaped legs 301, 302 has U-shaped grooves 310 which are adapted to corresponding protrusions 210 that are designed here to be cuboidal, said protrusions being fitted onto the outer sides of the second housing part 200 of the plug-in connector, in such a way that the cuboidal protrusions 210 are able to be slid into the grooves 310 of the locking clip 300. Latching hooks 320 are formed on the respective ends of the U-shaped limbs 301, 302, the front sides of which hooks, so their sides facing both housing parts 100, 200, having a respective slope 322. These obliquely running surfaces 322 are adapted to corresponding obliquely running surfaces 122 of snap-in noses 120 which are arranged on the first housing part 100.

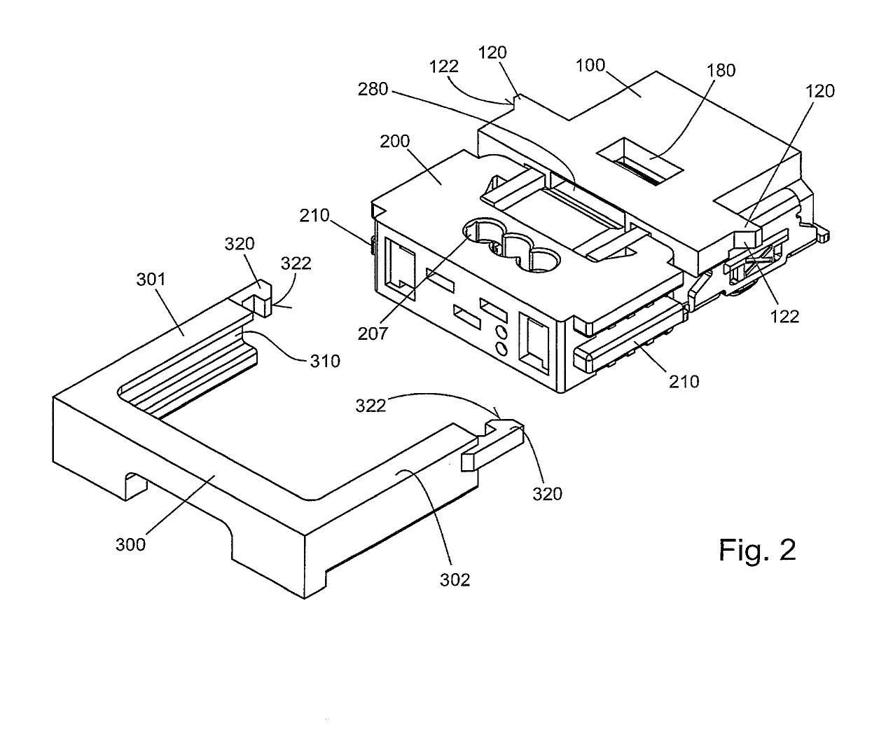

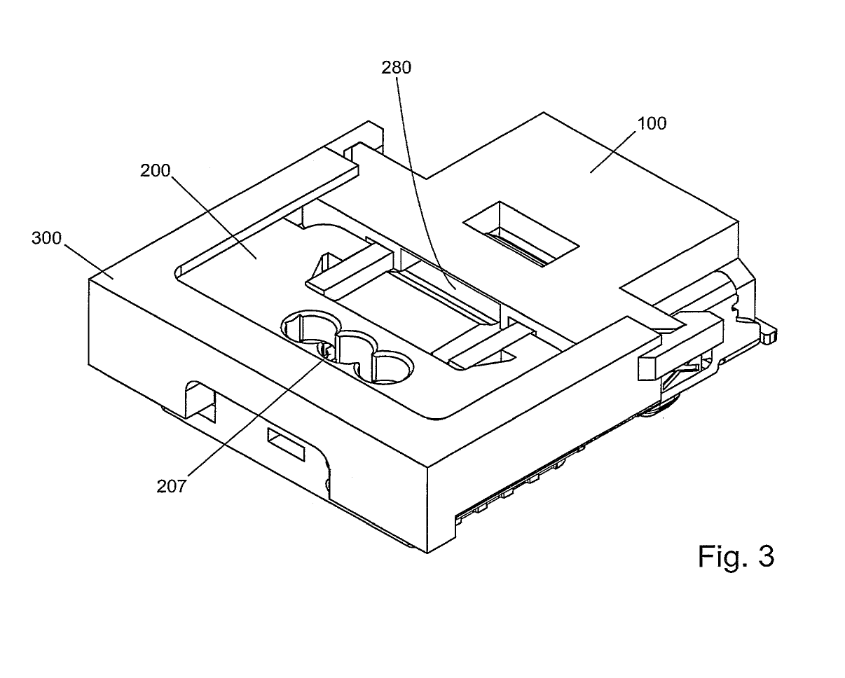

FIG. 1 shows the unplugged state of both housing parts 100, 200, whereas FIG. 2 shows the plugged state of both housing parts 100, 200. FIG. 1 and FIG. 2 each show the unlocked state, whereas FIG. 3 shows the plugged and locked state of both housing parts 100, 200. As can be gleaned from FIGS. 1 and 2, the housing part 200 has an elastic tongue 280 having a snap-in nose 290 that engages with an opening 180 provided in the housing part 100. Tongue 280, snap-in nose 290 and opening 180 thus already act as a primary locking agent, which ensures a locking of both housing parts 200 and 100 to each other. This locking is additionally ensured by the locking clip 300 that acts in this case as a secondary locking agent. After both housing parts 100, 200 have been plugged into each other, the locking clip 300 is slid above the second part 200, wherein the protrusions 210 engage with the grooves 310 and slide into the grooves 310. Then the latching hooks 320 lock on or with the snap-in noses 120 of the first housing part 100. The locking takes place while the second housing part 200 is secured by the locking clip 300. In this instance, the extensively arranged protrusions 210, which practically completely fill the grooves 310 in the locked state, prove to be highly advantageous. They enable not only a precise guiding of both U-shaped legs 301, 302 and thus also a precise guiding of the latching hooks 320 in the direction of the snap-in noses 120. They also enable a secure holding of the second housing part 200, in particular if pressure is exerted perpendicularly to the plugging direction, which is possible purely in principle, since the eduction of the electrical conductors takes place perpendicularly to the drawing plane by a ribbon cable or even individual wires, for example, being inserted into the opening 207, said cable or wires being contacted by means of insulation displacement contact in the second housing part 200, for example in the manner described in DE 10 2004 054 203 A1. The housing part 100 is, however, arranged on a circuit board, for example, and the contact elements are contacted on the circuit board by corresponding conducting paths. Purely as a matter of principle, the housing part 100 could, however, be designed in such a way that the electrical conductors are guided away perpendicularly from the drawing plane, such as in the case of the housing part 200, or even in parallel to the drawing plane, so parallel to the plugging direction.

The locking clip 300 is preferably a plastic part which has a certain level of elasticity, is light and is moreover also electrically insulating. The advantage of the described design of the locking clip 300 can be seen in that it is designed as a separate part. This enables not only simple handling, but it can also be exchanged easily if damaged and can be replaced by an undamaged locking clip 300. It furthermore extensively encloses the housing part 200, which ensures a secure locking, even secondary locking, of the second housing part 200 to the first housing part 100. Not only is a precise and firmly orientated guiding of the locking clip on the second housing part 200 and the latch elements on the first housing part 100 possible by the grooves formed in the inner sides of its legs 301, 302, which interact with corresponding protrusions 210 on the second housing part 200, but a particularly stable locking is also hereby achieved.

1. Electrical plug-in connector having a first housing part (100) and having a second housing part (200), wherein blade contact elements (105) are arranged in the first or second housing part (100, 200) and spring contact elements that are adapted to the blade contact elements (105) and are able to be plugged into them are arranged in the second or first housing part, comprising a locking clip (300) which is able to be locked in/on the second or first housing part (200, 100) while it encloses the first or second housing part substantially parallel to the plugging direction when both housing parts (100, 200) are plugged into each other.

2. Electrical plug-in connector according to claim 1, wherein guide elements running substantially parallel to the plugging direction are arranged in the first or second housing part (100, 200) for guiding clip arms of the locking clip (300).

3. Electrical plug-in connector according to claim 2, wherein latch elements are provided in the second or first housing part (200, 100) for locking with counterpart latch elements arranged on the clip arms.

4. Electrical plug-in connector according to claim 3, wherein the locking clip (300) is designed to be U-shaped, wherein the clip arms are two U-shaped limbs (301, 302) that are bent fundamentally orthogonally from a base.

5. Electrical plug-in connector according to claim 4, wherein the U-shaped legs (301, 302) have grooves (310) on their respective inner side facing towards the first or second housing part (100, 200), with which grooves the guide elements arranged on the second housing parts and designed as protrusions (210) engage in a sliding manner.

6. Electrical plug-in connector according to claim 4, wherein the U-shaped legs (301, 302) have latching hooks (320) as counterpart latch elements on their ends, which interact with latch elements formed as a snap-in nose (120) on the first or second housing part (100).

7. Electrical plug-in connector according to claim 6, wherein the latching hooks (320) and the snap-in noses (120) have, on their sides facing each other, sliding surfaces (322, 122) that are adapted to each other and run obliquely.

8. Electrical plug-in connector according to claim 1, wherein the locking clip (300) comprises plastic.

9. Electrical plug-in connector according to claim 1, wherein both housing parts (100, 200) have primary locking agents (180, 280, 290) and the locking clip (300) acts as a secondary locking agent.

10. Electrical plug-in connector according to claim 9, wherein the primary locking agent is formed by: a tongue (280) arranged on the second housing part (200), having a latching hook (290) that engages with an opening (180) arranged in the first housing part (100).
